(19) United States
(12) Patent Application Publication
(10) Pub. No.: US 2014/0170758 A1
(43) Pub. Date: Jun. 19, 2014

(54) SYSTEM AND METHOD FOR CONTROLLING A MICROFLUIDIC HANDLING DEVICE

(71) Applicant: GENERAL ELECTRIC COMPANY, Schenectady, NY (US)

(72) Inventors: Marko Klaus Baller, Saarbruecken (DE); Victor Donald Samper, Munchen (DE)

(73) Assignee: General Electric Company, Schenectady, NY (US)

(21) Appl. No.: 13/718,252

(22) Filed: Dec. 18, 2012

(51) Int. Cl. G01N 23/00

(52) U.S. Cl. CPC G01N 23/00
USPC 436/58; 422/68.1

(57) ABSTRACT

A system and method for controlling a microfluidic handling device is presented. One embodiment of the system includes a microfluidic synthesis cassette. Further, the system includes a synthesizer unit to receive the microfluidic synthesis cassette and execute one or more synthesis runs on the received microfluidic synthesis cassette to generate one or more radioactive doses. Also, the system includes an electronic dose tracker coupled to the microfluidic synthesis cassette to indicate a level of dose activity processed in the microfluidic synthesis cassette.

### BACKGROUND

Embodiments of the present disclosure relate generally to medical imaging, and more particularly to a system and a method for controlling a microfluidic handling device that is used for medical imaging.

Medical imaging is used extensively to diagnose and treat patients. More particularly, radiopharmaceuticals or radioactive tracers are used in a wide range of medical applications to generate medical images of a patient. These medical images may be generated using a number of imaging modalities, such as Positron Emission Tomography (PET) and Single Photon Emission Computed Tomography (SPECT).

PET and SPECT are classified as “nuclear medicine” because they measure the emission of a radioactive material which has been injected into a patient. After the radioactive material, e.g., radiopharmaceutical, is injected, it is absorbed by the blood or a particular organ of interest. The patient is then subjected to PET or SPECT detection which measures the emission of the radiopharmaceutical and creates an image from the characteristics of the detected emission. A significant step in conducting PET or SPECT scans is the acquisition and/or the manufacture of the radiopharmaceutical.

The half-lives of these radiopharmaceuticals typically range from two minutes to two hours. Thus, the injection into the patient and any subsequent imaging generally take place within a very short time period after production of the radiopharmaceuticals. Accordingly, these radiopharmaceuticals are often synthesized at on-site facilities or in local production facilities within suitable driving distance of the patient care site to prevent undue decay of the radiopharmaceuticals prior to use.

In order to meet the need of the growing practice of using nuclear medicine, portable or compact synthesizers have been developed to produce multiple radiotracers. Many of these compact synthesizers are arranged to use synthesis modules or cassettes for producing these radiopharmaceuticals or radioactive doses. After use, the cassette is required to be ejected from the synthesizer and a new cassette is to be loaded for producing any further radioactive doses. However, it is currently very difficult to track dose activity for a given cassette, which may be further used to control the synthesizers for producing the radiopharmaceuticals or radioactive doses. Thus, there is need for a method and system for controlling the microfluidic handling device for producing the radiopharmaceuticals.

### BRIEF DESCRIPTION

In accordance with one embodiment described herein, a system is presented. The system includes a microfluidic synthesis cassette. Further, the system includes a synthesizer unit to receive the microfluidic synthesis cassette and execute one or more synthesis runs on the received microfluidic synthesis cassette to generate one or more radioactive doses. Also, the system includes an electronic dose tracker coupled to the microfluidic synthesis cassette to indicate a level of dose activity processed in the microfluidic synthesis cassette.

In accordance with a further aspect of the present disclosure, a method is presented. The method includes receiving a microfluidic synthesis cassette and executing one or more synthesis runs on the received microfluidic synthesis cassette to generate one or more radioactive doses. Further, the method includes detecting a change in electrical properties of an electronic dose tracker coupled to the microfluidic synthesis cassette while executing the one or more synthesis runs on the received microfluidic synthesis cassette. Also, the method includes determining a level of dose activity processed in the microfluidic synthesis cassette based on the change in electrical properties of the electronic dose tracker.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a microfluidic handling device for generating radioactive doses in accordance with aspects of the present disclosure;

FIG. 2 is a block diagram of a synthesizer unit and a cassette in accordance with aspects of the present disclosure;

FIG. 3 is an illustration of a synthesizer unit loading an individual cassette in accordance with aspects of the present disclosure; and

FIG. 4 is a flow chart illustrating a method for controlling the microfluidic handling device of FIG. 1 to generate radioactive doses in accordance with aspects of the present disclosure.

### DETAILED DESCRIPTION

As will be described in detail hereinafter, various embodiments of exemplary structures and methods for controlling a microfluidic handling device are presented. By employing the methods and the various embodiments of the system described hereinafter, a level of dose activity in each of the cassettes is determined and accordingly the microfluidic handling device is controlled for generating one or more radioactive doses.

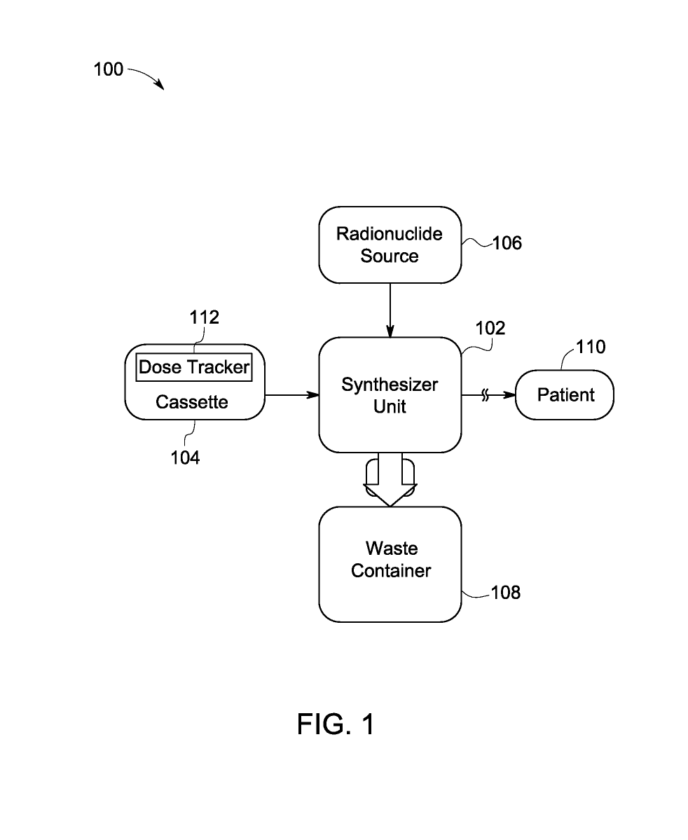

Turning now to the drawings, and referring to FIG. 1, a microfluidic handling device 100 for generating radioactive doses, in accordance with aspects of the present disclosure, is depicted. The device 100 includes a synthesizer unit 102 that is configured to generate one or more radioactive doses. The synthesizer unit 102 may be any suitable radiopharmaceutical synthesizer such as the FASTlab® sold by GE Healthcare, of Waukesha, Wis., for example. The synthesizer unit 102 may include actuators, sensors and a communication system (not shown in FIG. 1) to execute synthesis runs on a cassette 104 that is loaded into the synthesizer unit 102 for generating the one or more radioactive doses. It may be noted that the device 100 may include a plurality of cassettes that are serially loaded into the synthesizer unit 102. Further, the cassette 104 includes nonradioactive reagents and/or reaction conditions that are used for producing radiopharmaceuticals. As used herein, “radiopharmaceutical,” “radiotracer,” “tracer,” “radioactive label,” “doses,” and “radioactive doses” will be used interchangeably to mean a radioactive compound used in medical imaging and therapy. Also, as used herein the terms “cassette,” “cartridge,” and “microfluidic synthesis cassette” will be used interchangeably to mean a permanently installed or interchangeable element containing the full and/or partial fluid path of a device that is configured to produce tracers for use in medical imaging and therapy.

As will be appreciated, the synthesizer unit 102 may execute synthesis runs on the loaded cassette 104 according to particular parameters or a program associated with the cassette 104. Particularly, the synthesizer unit 102 receives radiation including radioactive reagents/species from a radionuclide source 106. Further, the received radioactive reagents/species is reacted with the nonradioactive reagents in the loaded cassette 104 based on pre-stored conditions or protocols to generate the one or more radioactive doses. More specifically, the radioactive reagent/species generated by the radionuclide source 106 may be injected into one or more channels on the loaded cassette 104 and may undergo various chemical processes until the desired radiopharmaceutical or dose is generated. Thereafter, the used cassette, which has residual radioactive activity, is ejected into a waste container 108. Also, the generated dose or radiopharmaceutical may be delivered to a patient 110 for therapy and/or imaging. In one embodiment, the generated dose or radiopharmaceutical may be further formulated into an injectable form prior to delivering to the patient 110. In one example, this formulation process may be executed within the synthesizer unit 102. It is to be noted that the device 100 is configured to generate a variety of radioactive doses or radiopharmaceuticals, depending on the type of the radionuclide source 106 and the cassette 104 availability.

In accordance with one embodiment, the exemplary microfluidic controlling device 100 includes an electronic dose tracker 112 that indicates a level of dose activity processed in the cassette 104. The level of dose activity may be indicated based on the amount of radiation the electronic dose tracker is exposed to while the synthesizer unit is executing the synthesis runs on the loaded cassette. In one example, the electronic dose tracker 112 may be an integrated circuit that may take the form of a smart card chip. The smart card chip may be similar to a chip found in mobile phones or bank cards, for example. Additional examples of the electronic dose tracker 112 may include a microchip coupled to the cassette 104, an electrical contact area, an optical means, or a RFID antenna coupled to a semiconductor device.

In a presently contemplated configuration, the cassette 104 may include the electronic dose tracker 112 prior to the cassette 104 being loaded into the synthesizer unit 102. It may be noted that each of the plurality of cassettes in the device 100 may include a corresponding electronic dose tracker. In one example, the electronic dose tracker 112 may be integrated into the cassette 104, whereas in another example, the electronic dose tracker 112 may be affixed or coupled to the cassette 104. The electronic dose tracker 112 includes an identifier corresponding to the cassette 104 to which the electronic dose tracker 112 is coupled to. In one embodiment, the electronic dose tracker 112 may be communicatively coupled to an external device (not shown in FIG. 1) from which the identifier corresponding to the cassette 104 is received. The identifier of the cassette 104 may take the form of or be stored within a bar code, an electronic unit, a Radio Frequency Identification (RFID) tag, and/or an identity tag, for example.

Further, when the cassette 104 is loaded into the synthesizer unit 102, the electronic dose tracker 112 provides the identifier of the loaded cassette 104 to the synthesizer unit 102. In one example, the electronic dose tracker 112 may send a signal to the synthesizer unit 102 that corresponds to the identifier of the cassette 104. The identifier of the loaded cassette 104 is then utilized by the synthesizer unit 102 to select an appropriate recipe or program for executing synthesis runs on the loaded cassette to generate the one or more radioactive doses.

In addition, the electronic dose tracker 112 is configured to indicate the level of dose activity processed in the cassette 104 to the synthesizer unit 102. Particularly, the synthesizer unit 102 may detect a change in electrical properties of the electronic dose tracker 112 due to exposure by the electronic dose tracker 112 to radiation from the radioactive species. In one example, the electronic dose tracker 112 may include a first electrical circuit that is communicatively coupled to a second electrical circuit in the synthesizer unit 102 when the cassette is loaded into the synthesizer unit 102. When the electronic dose tracker 112 is exposed to the radiation from the radioactive species, electrical properties in the first electrical circuit of the electronic dose tracker 112 are changed, which in turn predictably changes, for example, the flow of electric current from the first electrical circuit to the second electrical circuit. This change in the flow of electric current is utilized by the synthesizer unit 102 to estimate the level of dose activity processed in the cassette 104. In one embodiment, the dose activity may represent an amount of radioactivity on the cassette 104 and/or the electronic dose tracker 112 when the synthesizer unit 102 is executing the synthesis runs on the particular loaded cassette 104. In another example, the electronic dose tracker 112 may include a semiconductor element, such as photo detector (diode or transistor) or a radioactive sensor that is communicatively coupled to the second electrical circuit in the synthesizer unit 102. The second electrical circuit in the synthesizer unit 102 may detect a change in the electrical properties of the semiconductor element or the radioactive sensor as a result of the electronic dose tracker 112 being exposed to the radiation. This detected change in the electrical properties of the photo detector due to direct radioactive radiation may be used for determining the level of dose activity processed in the cassette 104. In one embodiment, the synthesizer unit 102 may detect the change in electrical properties of the electronic dose tracker 112 after executing the one or more synthesis runs on the received microfluidic synthesis cassette 104.

Further, the synthesizer unit 102 is configured to disable the loaded cassette 104 if the level of dose activity is above a threshold level. The threshold level may be pre-stored in the synthesizer unit 102. In one example, the threshold level may be referred to as a threshold amount of radioactivity on the cassette 104. In one embodiment, the synthesizer unit 102 may disable the loaded cassette 104 if a number of synthesis runs on the cassette 104 is above a threshold number. In one example, the synthesizer unit 102 may count the number of synthesis runs executed on the cassette 104.

Furthermore, the synthesizer unit 102 may disable the cassette by damaging the cassette 104 and/or invalidating the identifier of the cassette 104 in the electronic dose tracker 112, which in turn prevents the cassette 104 from generating any further radioactive doses. In one example, the identifier of the cassette 104 may be invalidated by deleting or removing the identifier from the cassette 104. In another example, the identifier of the cassette 104 may be invalidated by changing the identifier in the dose tracker 112. In one embodiment, the synthesizer unit 102 may disable the cassette 104 by breaking one or more fluid paths or channels in the cassette 104. Thus, the device 100 controls the synthesizer unit 102 in generating one or more radioactive doses based on the level of dose activity processed in the cassette 104.

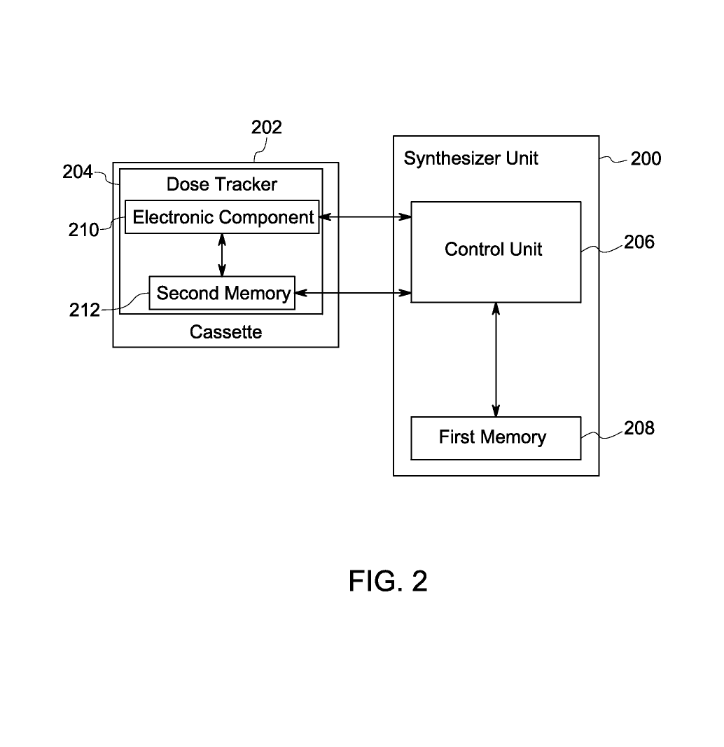

Referring to FIG. 2, a diagrammatical representation of a synthesizer unit and a cassette, in accordance with aspects of the present disclosure, is depicted. For ease of understanding of the present disclosure, the synthesizer unit and the cassette are described with reference to the components of FIG. 1. Reference numeral 200 may be representative of the synthesizer unit 102, reference numeral 202 may be representative of the cassette 104, and reference numeral 204 may be representative of the electronic dose tracker 112 of FIG. 1. The synthesizer unit 200 may include a control unit 206 and a first memory 208. In one embodiment, the first memory 208 may be an integrated memory of the control unit 206. Similarly, the electronic dose tracker 204 may include an electronic component 210 and a second memory 212, as depicted in FIG. 2. In one example, the second memory 212 may be an integrated memory of the electronic component 210. In another example, the second memory 212 may be a separate memory coupled to the electronic component 210, as depicted in FIG. 2.

In a presently contemplated configuration, when the cassette 202 is loaded into the synthesizer unit 200, the electronic component 210 and the second memory 212 in the cassette 202 may be communicatively coupled to the control unit 206 in the synthesizer unit 200. The electronic component 210 may include an integrated circuit that is electrically coupled to an electrical circuit in the control unit 206. The second memory 212 may include an identifier of the cassette 202 to which the electronic dose tracker 204 is coupled. In one embodiment, the electronic dose tracker 204 may be communicatively coupled to an external device (not shown) to receive the identifier of the cassette 202.

During operation, the control unit 206 may extract the identifier of the cassette 202 from the second memory 212 of the electronic dose tracker 204. Further, the control unit 206 may select a recipe or program associated with the cassette 202 based on the received identifier of the cassette 202. Particularly, the control unit 206 compares the received identifier of the cassette 202 with a plurality of pre-stored identifiers in the first memory 208. Each of these pre-stored identifiers is associated with a corresponding recipe or program that is stored in the first memory 208. The control unit 206 may select one of the pre-stored identifiers that matches with the received identifier of the cassette 202, which is further used to identify the corresponding recipe or program in the first memory 208.

Further, the control unit 206 may use the identified recipe for executing one or more synthesis runs on the loaded cassette 202. Particularly, the control unit 206 may use the identified recipe for executing the nonradioactive reagents in the cassette 202 to react with the radioactive reagents/species provided by the radionuclide source 106. More specifically, the radioactive reagent/species generated by the radionuclide source 106 may be injected into one or more channels on the loaded cassette 202 and may undergo various chemical processes, as guided by the received program or recipe, until the desired radiopharmaceutical or dose is generated.

In addition, while the synthesizer unit 200 is executing the synthesis run on the cassette 202, the electronic dose tracker 210 that is coupled to the loaded cassette 202 may indicate the level of dose activity processed in the cassette 202. Particularly, the control unit 206 that is coupled to the electronic component 210 in the electronic dose tracker 204 may detect a change in electrical properties of the electronic dose tracker 204 due to exposure by the electronic dose tracker 204 to radiation from the radioactive species. More specifically, one or more parameters of the electronic component 210 may vary when the electronic dose tracker 204 is exposed to radiation. The parameters may include impedance, voltage, current, and power in the electronic component 210. The control unit 206 may detect the change in electrical properties of the electronic dose tracker 204 based on the variation of the one or more parameters of the electronic component 210. In one embodiment, the control unit 206 may detect the change in electrical properties of the electronic dose tracker 204 when the electronic dose tracker 204 is in a powered state. The powered state may be referred to as a state where the power supply is provided to the electronic dose tracker 204. Furthermore, the control unit 206 determines the level of dose activity processed in the cassette 104 based on the detected change in electrical properties of the electronic dose tracker 204.

In accordance with aspects of the present disclosure, the control unit 206 may store the level of dose activity for one or more cassettes in the first memory 208. Also, the control unit 206 may send a signal corresponding to the level of dose activity for a given cassette to the second memory 212 in the electronic dose tracker 204 to store a representation of the level of dose activity in the second memory 212 of that cassette. Also, the control unit 206 may send a signal corresponding to a number of synthesis runs executed on the cassette 202 to store a representation of the number of synthesis runs in the second memory 212. In addition, the control unit 206 may be configured to disable the cassette 202 if the level of dose activity processed in the cassette 202 is above a threshold level. In one embodiment, the control unit 206 may disable the cassette 202 if the number of synthesis runs executed on the cassette 202 is above a threshold number or value.

Further, the control unit 206 may disable the cassette 202 by invalidating the identifier of the cassette 202 in the second memory 212, which in turn prevents the synthesizer unit 200 from determining the recipe or program for generating any further doses. In one example, the identifier of the cassette 202 may be invalidated by deleting the identifier or changing the identifier in the dose tracker 112. In one embodiment, the control unit 206 may disable the cassette 202 by sending a control signal to one or more actuators in the synthesizer unit 200 to break one or more fluid paths or channels in the cassette 202.

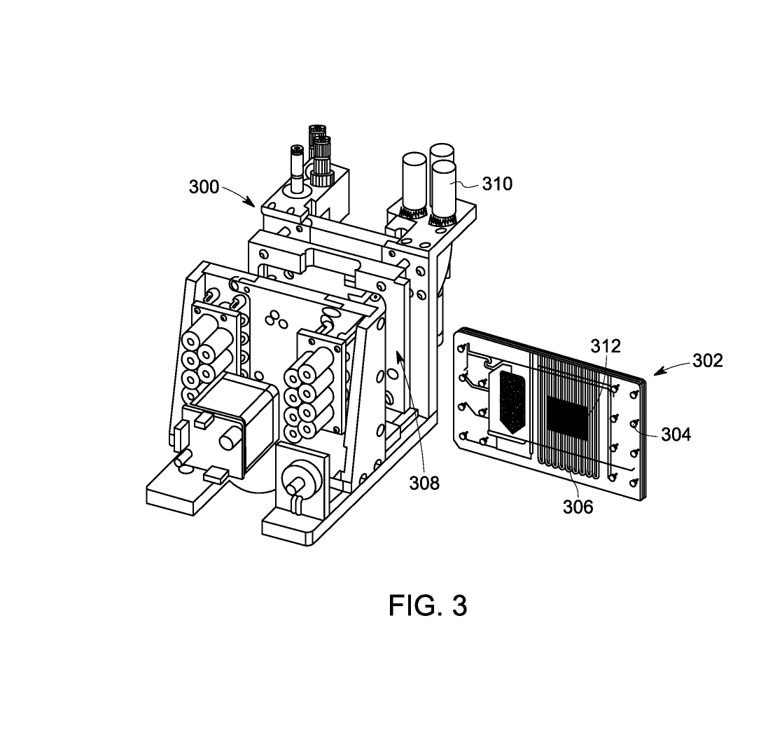

FIG. 3 is an illustration of a synthesizer unit loading an individual cassette into a cassette handling platform in accordance with aspects of the present disclosure. Reference numeral 300 may be representative of the synthesizer unit 102 and reference numeral 302 may be representative of the cassette 104 of FIG. 1.

In a presently contemplated configuration, the cassette 302 may be rotated or translated to align appropriate connectors 304, channels 306 and/or reagent reservoirs 310 with an entry passage 308 of the synthesizer unit 300. The reagent reservoirs 310 and/or channels 306 are used for storing nonradioactive reagents. It may be noted that in addition to the reagent reservoirs 310 and the channels 306, the synthesizer unit 300 may also include other components, such as a macro-chamber, a mixing unit, a fluid chamber, and/or a microfluidic reactor, for example.

Further, the synthesizer unit 300 is configured to receive radiation including radioactive reagents or species from the radionuclide source 106 via the reservoir 310. Also, these received radioactive reagents or species are made to react with the nonradioactive reagents to generate one or more radioactive doses in the synthesizer unit 300. More specifically, the radioactive reagents generated by the radionuclide source 106 may be injected into one or more channels 306 in the cassette 302 through the passage 310. Further, the nonradioactive reagents may react with these radioactive reagent or species and may undergo various chemical processes until the desired radiopharmaceutical or dose is generated.

In accordance with aspects of the present disclosure, an electronic dose tracker 312 that is coupled to the cassette 302 may control the chemical reaction for generating one or more radioactive doses. It may be noted that the electronic dose tracker 312 may be representative of the electronic dose tracker 112 of FIG. 1. More particularly, a control unit (such as the control unit 206) in the synthesizer unit 300 may detect a change in electrical properties of the electronic dose tracker 312 when the electronic dose tracker 312 is exposed to radiation. Further, the control unit 206 determines the level of dose activity processed in the cassette 302 based on the detected change in electrical properties of the electronic dose tracker 312. If the level of dose activity processed in the cassette 302 is above a threshold level, the control unit 206 may disable the cassette 302 to restrict the synthesizer unit 300 from executing any further synthesis runs on the cassette 302. In one embodiment, the control unit 206 may disable the cassette 302 if a number of synthesis runs executed on the cassette 302 is above a threshold number. Further, the control unit 206 may disable the cassette 302 by damaging or breaking the one or more channels/fluid paths 306 in the cassette 302, via actuators. It is to be noted that the terms “channels” and “fluid paths” may be used interchangeably. In another embodiment, the control unit 206 may remove or delete the identifier of the cassette 302 from the electronic dose tracker 312, which in turn prevents the synthesizer unit 300 from identifying the recipe of the cassette 302.

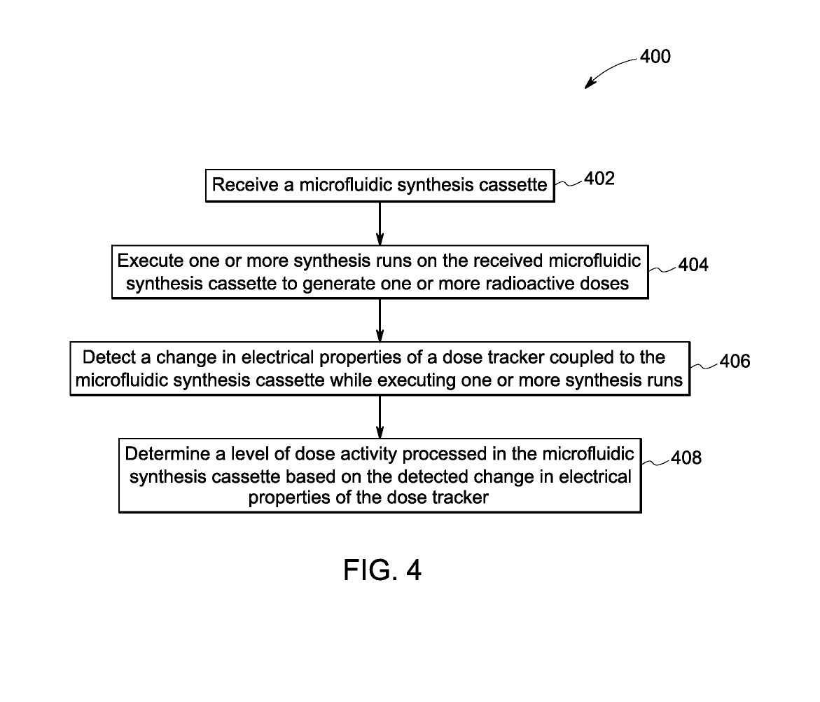

Referring to FIG. 4, a flow chart illustrating a method 400 for controlling the microfluidic handling device of FIG. 1 to generate one or more radioactive doses, in accordance with aspects of the present disclosure, is depicted. For ease of understanding of the present disclosure, the method is described with reference to the components of FIGS. 1-4. The method begins at step 402, where a microfluidic synthesis cassette 302 including nonradioactive reagents is loaded into a synthesizer unit 300. Particularly, the cassette 302 may be rotated or translated to align appropriate reagent reservoirs 310 and/or channels 306 with an entry passage 308 of the synthesizer unit 300. Further, when the cassette 302 is loaded into the synthesizer unit 300, an electronic dose tracker 312 in the cassette 302 may provide an identifier of the loaded cassette 302 to a control unit, such as the control unit 206. The identifier of the loaded cassette 302 is then utilized by the control unit 206 to select a recipe for generating one or more radioactive doses. In one embodiment, the electronic dose tracker 312 may be communicatively coupled to an external device to receive the identifier corresponding to the cassette 302. The identifier of the cassette 302 may take the form of or be stored within a bar code, an electronic unit, a Radio Frequency Identification (RFID) tag, and/or an identity tag, for example.

Subsequently, at step 404, one or more synthesis runs are executed on the received microfluidic synthesis cassette to generate one or more radioactive doses. To that end, the synthesizer unit 300 is configured to execute the one or more synthesis runs on the cassette 302 by utilizing the non-radioactive reagents in the microfluidic synthesis cassette 302 and radioactive reagents or species received from the radionuclide source 106. Particularly, the radioactive reagent or species generated by the radionuclide source 106 may be injected into one or more channels on the cassette 302 and may undergo various chemical processes until the desired radiopharmaceutical or dose is generated.

In addition, at step 406, a change in electrical properties of the electronic dose tracker 312 coupled to the cassette 302 is detected while or after executing the one or more synthesis runs. To that end, the control unit 206 in the synthesizer unit 300 may simultaneously detect a change in electrical properties of the electronic dose tracker 312 when the one or more synthesis runs are executed on the cassette 302. Particularly, an electronic component 210 in the electronic dose tracker 312, 204 may be coupled to the control unit 206 in the synthesizer unit 300, 200. This electronic component 210 may undergo change in one or more parameters when the electronic dose tracker 312, 204 is exposed to radiation. The one or more parameters may include impedance, current, voltage, and power in the electronic component 210.

Subsequently, at step 408, a level of dose activity processed in the cassette 302, 202 may be determined based on the detected change in electrical properties of the electronic dose tracker 312, 204. To that end, the control unit 206 may determine the level of dose activity processed in the cassette 302, 202. The level of dose activity may include an amount of radiation or radioactivity on the cassette 302, 202. Moreover, the control unit 206 may disable the cassette 302, 202 if the level of dose activity processed in the cassette 302, 202 is above a threshold level. In on embodiment, the control unit 206 may disable the cassette 302, 202 if the number of synthesis runs is above a threshold number. The cassette 302, 202 may be disabled by breaking one or more fluid paths or channels in the cassette 302, 202. In another embodiment, the cassette 302, 202 may be disabled by invalidating the identifier of the cassette 302, 202 in the electronic dose tracker 312, 204.

The various embodiments of the system and method aid in controlling the level of dose activity processed in the cassette. Also, the used cassettes are prevented from using for other synthesis or larger activities.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a microfluidic synthesis cassette;
a synthesizer unit to:
receive the microfluidic synthesis cassette; and
execute one or more synthesis runs on the received microfluidic synthesis cassette to generate one or more radioactive doses; and
an electronic dose tracker coupled to the microfluidic synthesis cassette to indicate a level of dose activity processed in the microfluidic synthesis cassette.

2. The system of claim 1, wherein the electronic dose tracker indicates the level of dose activity based on a detected change in electrical properties of the electronic dose tracker due to exposure to radiation.

3. The system of claim 2, wherein the dose activity comprises an amount of radiation to which the electronic dose tracker is exposed to when the synthesizer unit is generating the one or more radioactive doses.

4. The system of claim 2, wherein the electronic dose tracker comprises an electronic component to change the electrical properties of the electronic dose tracker when the electronic dose tracker is exposed to the radiation.

5. The system of claim 2, wherein the change in electrical properties of the electronic dose tracker is detected when the electronic dose tracker is in a powered state.

6. The system of claim 2, wherein the synthesizer unit comprises a control unit communicatively coupled to the electronic component to:
detect the change in electrical properties of the electronic dose tracker; and
determine the level of dose activity processed in the microfluidic synthesis cassette based on the detected change in electrical properties of the electronic dose tracker.

7. The system of claim 6, wherein the synthesizer unit comprises a first memory to store the level of dose activity processed in the microfluidic synthesis cassette.

8. The system of claim 6, wherein the electronic dose tracker comprises a second memory to receive from the control unit, a signal corresponding to the level of dose activity processed in the microfluidic synthesis cassette and to store a representation of the level of dose activity.

9. The system of claim 6, wherein the second memory is configured to receive from the control unit, a signal corresponding to a number of synthesis runs executed by the synthesizer unit using the microfluidic synthesis cassette and to store a representation of the number of synthesis runs.

10. The system of claim 9, wherein the electronic dose tracker is communicatively coupled to an external device to receive an identifier of the microfluidic synthesis cassette.

11. The system of claim 9, wherein the control unit disables the microfluidic synthesis cassette by invalidating the identifier of the microfluidic synthesis cassette in the second memory.

12. The system of claim 6, wherein the synthesizer unit disables the microfluidic synthesis cassette when the number of synthesis runs on the microfluidic synthesis cassette is above a threshold number.

13. The system of claim 6, wherein the control unit disables the microfluidic synthesis cassette when the level of dose activity processed in the microfluidic synthesis cassette is above to a threshold level.

14. The system of claim 6, wherein the synthesizer unit disables the microfluidic synthesis cassette by breaking a fluid path in the microfluidic synthesis cassette.

15. A method comprising:
receiving a microfluidic synthesis cassette;
executing one or more synthesis runs on the received microfluidic synthesis cassette to generate one or more radioactive doses;
detecting a change in electrical properties of an electronic dose tracker coupled to the microfluidic synthesis cassette while executing the one or more synthesis runs on the received microfluidic synthesis cassette; and
determining a level of dose activity processed in the microfluidic synthesis cassette based on the change in electrical properties of the electronic dose tracker.

16. The method of claim 15, wherein determining the level of dose activity comprises estimating an amount of radiation to which the electronic dose tracker is exposed to while generating the one or more radioactive doses using the microfluidic synthesis cassette.

17. The method of claim 16, wherein the change in electrical properties of the electronic dose tracker is detected after executing the one or more synthesis runs on the received microfluidic synthesis cassette.

18. The method of claim 15, wherein determining the level of dose activity comprises storing the level of dose activity in at least one of a first memory and a second memory.

19. The method of claim 15, further comprising disabling the microfluidic synthesis cassette by breaking at least one fluid path in the microfluidic synthesis cassette when the level of dose activity is above a threshold level.

20. The method of claim 15, further comprising disabling the microfluidic synthesis cassette when a number of synthesis runs on the received microfluidic synthesis cassette is above a threshold number.
